(19) United States
(12) Patent Application Publication
(10) Pub. No.: US 2023/0099596 A1
(43) Pub. Date: Mar. 30, 2023

(54) SYSTEM AND METHOD FOR A WEARABLE AIR FILTRATION DEVICE

(71) Applicant: Pradeep Ramasubramanian, Portland, OR (US)

(72) Inventor: Pradeep Ramasubramanian, Portland, OR (US)

(21) Appl. No.: 17/459,923

(22) Filed: Sep. 27, 2021

(51) Int. Cl. A62B 7/10; B01D 46/10; B01D 46/42; B01D 39/20; B01D 46/00; B01D 46/24; A62B 18/00

(52) U.S. Cl. CPC A62B 7/10; B01D 46/10; B01D 46/4245; B01D 39/2055; B01D 46/0043; B01D 46/0049; B01D 46/2411; B01D 46/0023; A62B 18/003; B01D 2267/40

(57) ABSTRACT

An air filtration system is disclosed. The system comprises an air conduit having an inlet and an outlet, a self-contained electric power source, an electrically powered fan, an air filter located transversely across said air conduit, and an air boundary containment nozzle at the outlet of the air conduit. The nozzle has an outlet diameter of between about 0.5 centimeters and about 4 centimeters. The nozzle minimizes the mixing of the unfiltered ambient air with the filtered air directed to the wearer.

### BACKGROUND

### 1. Technical Field

The technology relates to systems and methods for filtering air. Further, the technology relates to systems and methods for controlling an airstream.

### 2. Description of Related Art

So as to reduce the complexity and length of the Detailed Specification, and to fully establish the state of the art in certain areas of technology, Applicant(s) herein expressly incorporate(s) by reference all of the following materials identified in each numbered paragraph below.

U.S. Pat. No. 9,205,218B1 describes a wearable air purifier assembly.

Korean Patent Application No. describes a wearable air cleaning apparatus.

Taiwan Patent No.: TW201808381A describes a wearable device having a gas filtering unit.

CN Patent No. CN208418993U describes a respiratory protection equipment.

Applicant(s) believe(s) that the material incorporated above is “non-essential” in accordance with 37 CFR 1.57, because it is referred to for purposes of indicating the background of the invention or illustrating the state of the art. However, if the Examiner believes that any of the above-incorporated material constitutes “essential material” within the meaning of 37 CFR 1.57(c)(1)-(3), Applicant(s) will amend the specification to expressly recite the essential material that is incorporated by reference as allowed by the applicable rules.

### SUMMARY

The present technology provides, among other things, a wearable personal air cleaning device which may include the filtration of air and the direction of the airstream to a designated position without entraining unfiltered air. The technology may use a prescribed nozzle geometry.

In some embodiments, the wearable personal air cleaning device may include an air conduit, an electric power source, an electrically powered fan, an air filter, and an air boundary containment nozzle.

In many embodiments, the opening of the nozzle is directed towards a wearer's face. In many embodiments, the nozzle is directed to the wearer's nasal cavity openings.

In some embodiments, the air filter may include a prefilter. The prefilter may be a large particle filter. In many embodiments, the air filter may include a nanofiber filter. In some embodiments, the air filter may include an activated carbon filter. In some embodiments, the air filters are placed in a serviceable carrier.

In many embodiments, the wearable personal air cleaning device includes one fan. In some embodiments, the fan is located upstream of the air filters. In other embodiments, the fan is located downstream of the air filters. In some embodiments, the wearable personal air cleaning device includes two fans. The fans may be located such that a first fan is located upstream and a second fan is located downstream of the air filters.

In some embodiments, the prescribed nozzle geometry creates a boundary layer preventing the entrainment of unfiltered air into the airstream. The flow of fluid may have a Reynolds number that falls within the transition from laminar flow to turbulent flow. The difference in viscosity between the expelled filtered and ambient unfiltered air creates the boundary layer. The boundary layer occurs because the difference in viscosity is unstable, which may create an oscillation. The nozzle aims the instability to a sufficiently distant point. In many embodiments, the outlet containing the nozzle may be detachable from the air conduit. The outlet may be attached to the air conduit by a locking mechanism.

Aspects and applications of the invention presented here are described below in the drawings and detailed description of the invention. Unless specifically noted, it is intended that the words and phrases in the specification and the claims be given their plain, ordinary, and accustomed meaning to those of ordinary skill in the applicable arts. The inventor is fully aware that he can be his own lexicographer if desired. The inventor expressly elects, as his own lexicographers, to use only the plain and ordinary meaning of terms in the specification and claims unless he clearly states otherwise and then further, expressly sets forth the “special” definition of that term and explains how it differs from the plain and ordinary meaning. Absent such clear statements of intent to apply a “special” definition, it is the inventor's intent and desire that the simple, plain and ordinary meaning to the terms be applied to the interpretation of the specification and claims.

The inventor is also aware of the normal precepts of English grammar. Thus, if a noun, term, or phrase is intended to be further characterized, specified, or narrowed in some way, then such noun, term, or phrase will expressly include additional adjectives, descriptive terms, or other modifiers in accordance with the normal precepts of English grammar. Absent the use of such adjectives, descriptive terms, or modifiers, it is the intent that such nouns, terms, or phrases be given their plain, and ordinary English meaning to those skilled in the applicable arts as set forth above.

Further, the inventor is fully informed of the standards and application of the special provisions of 35 U.S.C. § 112(f). Thus, the use of the words “function,” “means” or “step” in the Detailed Description or Description of the Drawings or claims is not intended to somehow indicate a desire to invoke the special provisions of 35 U.S.C. § 112(f), to define the invention. To the contrary, if the provisions of 35 U.S.C. § 112(f) are sought to be invoked to define the inventions, the claims will specifically and expressly state the exact phrases “means for” or “step for, and will also recite the word “function” (i.e., will state “means for performing the function of [insert function]”), without also reciting in such phrases any structure, material or act in support of the function. Thus, even when the claims recite a “means for performing the function of . . . ” or “step for performing the function of . . . ,” if the claims also recite any structure, material or acts in support of that means or step, or that perform the recited function, then it is the clear intention of the inventor not to invoke the provisions of 35 U.S.C. § 112(f). Moreover, even if the provisions of 35 U.S.C. § 112(f) are invoked to define the claimed inventions, it is intended that the inventions not be limited only to the specific structure, material or acts that are described in the preferred embodiments, but in addition, include any and all structures, materials or acts that perform the claimed function as described in alternative embodiments or forms of the invention, or that are well known present or later-developed, equivalent structures, material or acts for performing the claimed function.

The foregoing and other aspects, features, and advantages will be apparent to those artisans of ordinary skill in the art from the DETAILED DESCRIPTION and DRAWINGS, and from the CLAIMS.

### BRIEF DESCRIPTION OF THE SEVERAL VIEWS OF THE DRAWINGS

A more complete understanding of the present invention may be derived by referring to the detailed description when considered in connection with the following illustrative figures. In the figures, like reference numbers refer to like elements or acts throughout the figures.

FIG. 1 depicts a front perspective view of an air filtration device.

FIG. 2 depicts a front perspective view of the air filtration device and a serviceable filtration housing.

FIG. 3 depicts a front view of the air filtration device worn by an individual with reference planes.

FIG. 4 depicts a front view of the air filtration device worn by an individual with reference planes.

FIG. 5 depicts a side view of the air filtration device worn by an individual with a reference plane.

Elements and acts in the figures are illustrated for simplicity and have not necessarily been rendered according to any particular sequence or embodiment.

### DETAILED DESCRIPTION

In the following description, and for the purposes of explanation, numerous specific details are set forth in order to provide a thorough understanding of the various aspects of the invention. It will be understood, however, by those skilled in the relevant arts, that the present invention may be practiced without these specific details. In other instances, known structures and devices are shown or discussed more generally in order to avoid obscuring the invention. In many cases, a description of the operation is sufficient to enable one to implement the various forms of the invention, particularly when the operation is to be implemented in software. It should be noted that there are many different and alternative configurations, devices and technologies to which the disclosed inventions may be applied. The full scope of the inventions is not limited to the examples that are described below.

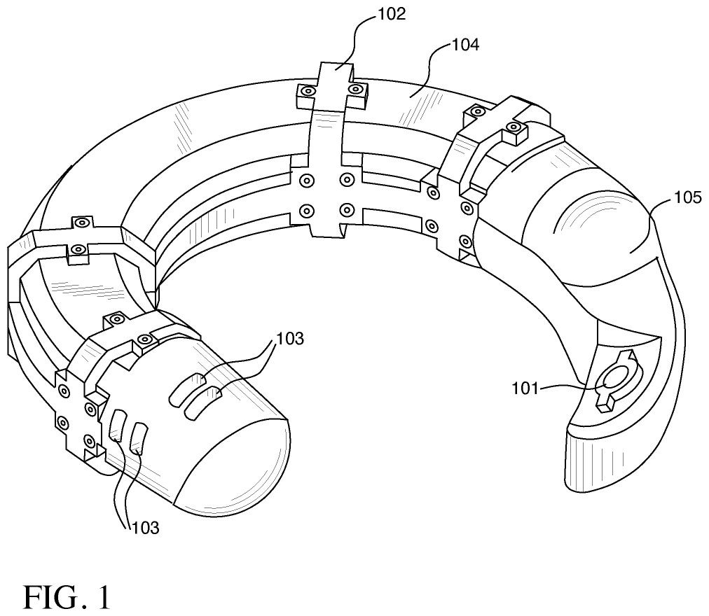

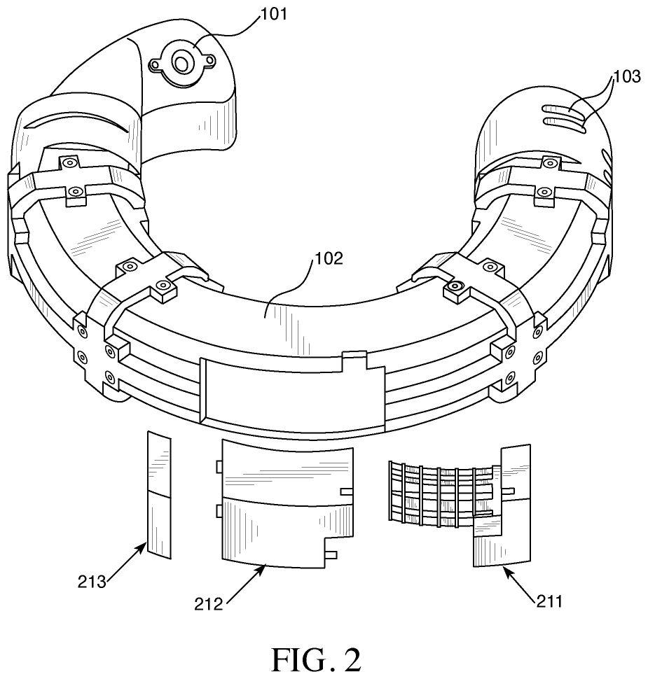

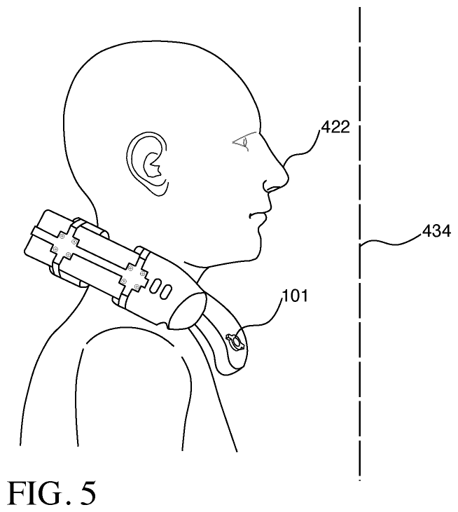

FIGS. 1 through 5 illustrate a wearable air filtration system, which comprises an air inlet 103, an air conduit 104, a filter housed within a filter housing 211 attached within the frame 102, and an outlet chamber 105 with an outlet nozzle 101.

A non-exhaustive purpose of the air filtration system is to filter ambient air of matter harmful to the wearer. The system may be in an open ring-like shape and may be worn over the wearer's shoulder such that the outlet directs filtered air to the wearer's nasal cavity. The system may deliver the filtered air to the wearer by an air boundary containment nozzle 101. The nozzle 101 is advantageous because the geometry prevents mixing of the filtered air with the ambient unfiltered air. The geometry of the nozzle 101 modifies the flow of the filtered air relative to the ambient unfiltered air and utilizes certain boundary condition differences between the filtered and unfiltered air to minimize entrainment.

In some embodiments, unfiltered air enters the air conduit 104 within the air filtration device 100 at the one or more air inlets 103. In many embodiments, the one or more air inlets may be positioned outside the air boundary containment nozzle 101 air stream. In other embodiments, the one or more inlet airstreams from the one or more inlets may be positioned such that the inlet airstreams do not interfere with the one or more outlet airstreams. In some embodiments, the air inlet geometry may be any shape or size. In many embodiments, the air inlet geometry is round or ovular.

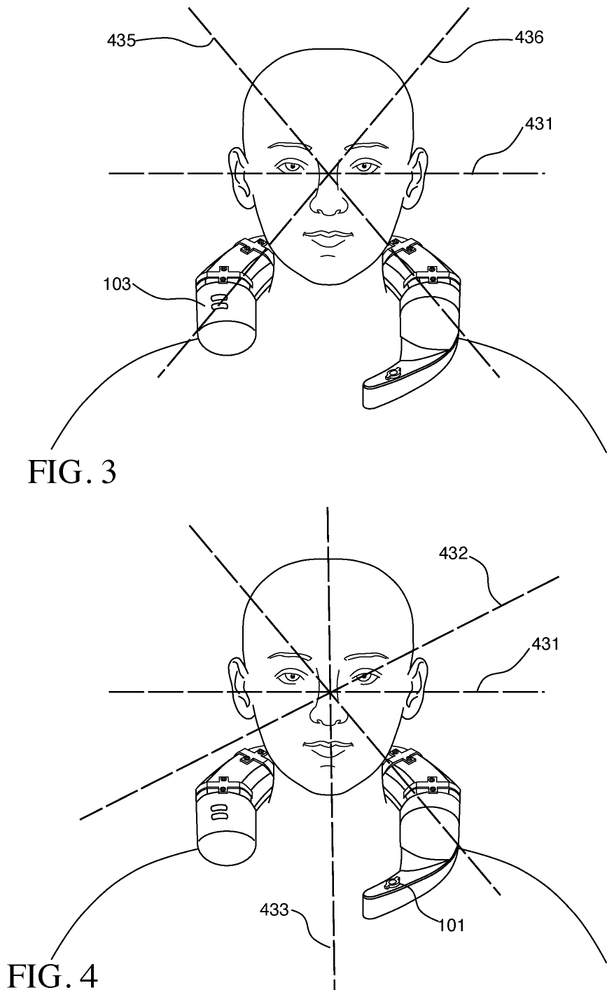

Referring to FIG. 3, in some embodiments, the inlet nozzle may be directed to an area between a third plane 435 and a fourth plane 436.

In some embodiments, the third plane 435 may be at an angle of about 45 degrees superior to the reference plane (431). Superior to the reference plane is defined as in the direction towards the top of the head of the wearer. In many embodiments, the third plane 435 may be at an angle between the range of about 0 degrees to about 45 degrees superior to the reference plane 431. In some embodiments, the third plane 435 may be at an angle between about 0 degrees to about 15 degrees superior to the reference plane 431. In many embodiments, the third plane 435 may be at an angle between 15 degrees to about 30 degrees superior to the reference plane. In some embodiments, the third plane 435 may be at an angle between about 30 degrees to about 45 degrees superior to the reference plane.

In some embodiments, the fourth plane 436 may be at an angle of about 65 degrees inferior to the reference plane (431). Inferior to the reference plane is defined as in the direction towards the feet of the wearer. In many embodiments, the fourth plane 436 may be at an angle between the range of about 0 degrees to about 65 degrees inferior to the reference plane 431. In some embodiments, the fourth plane 436 may be at an angle between the range of about 0 degrees to about 15 degrees inferior to the reference plan 431. In many embodiments, the fourth plane 436 may be at an angle between the range of about 15 degrees to about 30 degrees inferior to the reference plan 431. In some embodiments, the fourth plane 436 may be at an angle between the range of about 30 degrees to about 45 degrees inferior to the reference plan 431. In many embodiments, the fourth plane 436 may be at an angle between the range of about 45 degrees to about 65 degrees inferior to the reference plan 431.

In many embodiments, the unfiltered air is propelled into the air conduit 104 by one or more fans. In some embodiments, the unfiltered air enters the air conduit 104 because of the low-pressure zone caused by the one or more fans. In some embodiments, the air is propelled along the air conduit 104 by the one or more fans. In many embodiments, the air is propelled through the air conduit 104 by two fans. In other embodiments, the air passes through one or more air filters.

In some embodiments, the one or more fans are electrically powered by one or more batteries. In many embodiments, the one or more fans are positioned within the air conduit 104. In some embodiments, the one or more fans are positioned outside the air conduit 104 with a fan outlet air stream directed towards the air conduit 104. In some embodiments, the one or more fans are coupled to the interior of the frame 102. In many embodiments the one or more fans' axis of rotation is oriented perpendicular to the long axis of the air conduit 104. In some embodiments the one or more fans are placed in series. In other embodiments the one or more fans are placed in parallel.

In some embodiments, the air passes a pre-filter. The pre-filter may remove large particles. In many embodiments, the inclusion of a pre-filter may increase the usable lifespan of downstream air filters in the air conduit 104. In some embodiments the air is filtered by a nano-fiber filter. In some embodiments, the air is filtered by a HEPA filter. In many embodiments, the air passes through an air filter which filters particles of a prescribed size. The prescribed size may be about 0.3 microns or less. In some embodiments, the prescribed size may be about 0.2 microns or less. In some embodiments, the prescribed size may be about 0.1 microns. In some embodiments, the air passes through a carbon filter. The carbon filter may be used to reduce the amount of volatile organic compounds in the air. The carbon filter may be used to reduce odors in the air.

In some embodiments, the filter housing 211 is placed within the air filtration device in the path of the airstream in the air conduit 104. A filter housing plate 212 is attached to the frame 102. The filter housing plate 212 minimizes air leakage out of the air conduit 104 from the filter housing 211. The air filter locking plate 213 attaches to the frame 102 and prevents the movement of both the filter housing plate 212 and the filter housing 211.

In some embodiments, the filter housing 211 consists of a tubular shape. The tubular shape increases the available surface area relative. In other embodiments, the filter housing 211 contains flat sheets of the air filtration material. In many embodiments, the unfiltered air first passes the pre-filter, secondly passes the nanofiber filter, and finally passes the activated carbon filter. In other embodiments, the unfiltered air first passes the pre-filter, secondly passes the activated carbon filter, and finally passes the nanofiber filter.

In some embodiments, the nanofiber may be inserted into the filter housing 211. In other embodiments, the nanofiber filter may be wrapped around the filter housing 211. In many embodiments, the nanofiber may be loosely packed into the filter housing 211. In other embodiments, the nanofiber may be tightly packed into the filter housing 211.

In some embodiments the nanofiber filter may be comprised of PAN polymer sheets. In other embodiments, the nanofiber filter may be comprised of PVGL polymer sheets.

In some embodiments, the pressure drop across the one or more filters may be 1.4 inches of water column. In other embodiments, the pressure drop across the one or more filters may be between about 0.75 to about 1.4 inches of water column.

In some embodiments, the batteries may be connected in parallel. In many embodiments, the batteries may be connected in series. In some embodiments the battery may be rechargeable. In many embodiments the battery chemistry may be lead-, nickel-, or lithium-based.

In some embodiments, the outlet is radially attached to the frame 102. In many embodiments the outlet chamber 105 may be connected with an extendable device. An example of such an attachment mechanism is a corrugated accordion tube. In other embodiments, the attachment mechanism may be attached by a flexible tube. The flexible tube allows for the nozzle to be positioned in the optimal position relative to the user's nasal passageway.

In many embodiments the nozzle 101 is molded together with the outlet assembly. In some embodiments the nozzle 101 is detachable. In some embodiments, the nozzle is directed towards the user's nasal passageway. In many embodiments the Reynolds number at the nozzle 101 is about 500 and about 10,000. The flow of fluid with a Reynolds number in the aforementioned range falls within the transition from laminar flow to turbulent flow. The difference in viscosity causes an oscillation thereby creating a boundary layer between the filtered air exiting the nozzle 101 and the surrounding unfiltered air. The difference in viscosity is unstable and the outlet nozzle 101 aims the instability to a sufficiently distant point resulting in a clear boundary between inertial flow versus viscous flow thereby separating the filtered and unfiltered air. In some embodiments, the Strouhal number at the nozzle 101 is between about 1.0e-5 to about 0.5. In some embodiments, the axial entrainment coefficient, α, is between about 0.03 to about 0.2. In many embodiments, the axial entrainment coefficient α, is between about 0.03 to about 0.1. In other embodiments, the axial entrainment coefficient α, is between about 0.1 to about 0.2. In some embodiments, the cross-flow entrainment coefficient, β, is between about −0.6 to about 1. In many embodiments, the cross-flow entrainment coefficient, β, is between about −0.6 to about 0. In other embodiments, the cross-flow entrainment coefficient, β, is between about 0 to about 0.5. In many embodiments, the cross-flow entrainment coefficient, β, is between about 0.5 to about 1. In some embodiments, the outlet nozzle 101 is about 1 cm to about 12 cm. In some embodiments, the flow rate at the outlet nozzle 101 is ten to twenty cubic feet per minute. The aforementioned factors are necessary to overcome the thermal plume emanating from the wearer's body.

In some embodiments, the air boundary containment nozzle is constrained by two planes. In some embodiments, the first plane 432 may be at an angle of about 15 degrees superior to the reference plane 431. Superior to the reference plane is defined as in the direction towards the top of the head of the wearer. In many embodiments, the first plane 432 may be at an angle between the range of about 0 degrees to about 5 degrees superior to the reference plane 431. In some embodiments, the first plane 432 may be at an angle between about 5 degrees to about 10 degrees superior to the reference plane 431. In many embodiments, the first plane 432 may be at an angle between 10 degrees to about 15 degrees superior to the reference plane. In some embodiments, the second plane 433 is a median plane that bisects the wearer. In many embodiments, the second plane 433 is orthogonal to the reference plane 431.

[Outlet Position] In some embodiments, the air boundary containment nozzle is directed to an area between about 2 centimeters to about 10 centimeters anterior from the tip of a user's nose. In other embodiments, the air boundary containment nozzle is directed to a region marked by a nose plane 434 10 centimeters or less from the tip of the nose.

[Outlet Position] In some embodiments, the inlet is constrained by two planes. In some embodiments, the third plane 435 may be at an angle of about 45 degrees superior to the reference plane 431. In many embodiments, the third plane 435 may be at an angle between the range of about 0 degrees to about 15 degrees superior to the reference plane 431. In some embodiments, the third plane 435 may be at an angle between about 15 degrees to about 30 degrees superior to the reference plane 43. In many embodiments, the third plane 435 may be at an angle between 30 degrees to about 45 degrees superior to the reference plane.

[Inlet Position] In some embodiments, the fourth plane 436 may be at an angle of about 65 degrees inferior to the reference plane 431. In many embodiments, the fourth plane 436 may be at an angle between the range of about 0 degrees to about 15 degrees inferior to the reference plane 431. In some embodiments, the fourth plane 436 may be at an angle between about 15 degrees to about 30 degrees inferior to the reference plane 431. In many embodiments, the fourth plane 436 may be at an angle between 30 degrees to about 45 degrees inferior to the reference plane. In some embodiments, the fourth plane 436 may be at an angle between about 45 degrees to about 60 degrees inferior to the reference plane 431.

[Handheld/Stand] In some embodiments, the wearable air filtration system may be placed onto a stand for handsfree use.

I claim:

1. An electrically, wearable personal air cleaning device comprising:
an air conduit having an inlet and an outlet;
a self-contained electric power source;
an electrically powered fan;
an air filter located transversely across said air conduit; and
an air boundary containment nozzle at the outlet of the air conduit, wherein the nozzle has an outlet diameter of between about 0.5 centimeters and about 4 centimeters.

2. The air boundary containment nozzle of claim 1, wherein the opening of the nozzle is directed towards a wearer's face.

3. The air boundary containment nozzle of claim 2, wherein the opening of the nozzle is further directed towards the base of wearer's nasal cavity openings.

4. The air boundary containment nozzle of claim 2, wherein the nozzle is further directed to an area constrained by two planes comprising:
a first plane forming an angle of about 15 degrees superior to a reference plane, wherein the reference plane is parallel to a transverse plane and located about four centimeters above the wearer's nasal cavity openings.
a second plane comprising a median plane that bisects the wearer.

5. The air boundary containment nozzle of claim 2, wherein the nozzle is located between about 2 centimeters and about 10 centimeters anterior from the tip of the nose.

6. The air boundary containment nozzle of claim 2, wherein the nozzle is located between about 2 centimeters to about 15 centimeters laterally from the median plane that bisects the wearer towards the location of the nozzle.

7. The inlet of claim 1, wherein the inlet is directed to an area between two planes comprising:
a third plane forming an angle of about 45 degrees superior to the reference plane, wherein the reference plane is parallel to a transverse plane and located about four centimeters above the wearer's nasal cavity openings;
a fourth plane forming an angle of about 65 degrees inferior to the reference plane;

8. The air filters of claim 1 wherein the filters further comprising:
a prefilter, comprising a large particle filter;
a nanofiber filter; and
an activated carbon filter.

9. The fan of claim 1, further comprising:
at least two electrically powered fans.

10. The electrically powered fans of claim 10 further comprising:
a first fan located upstream of the air filters; and
a second fan located downstream of the air filters.

11. The electrically powered fans of claim 10 further comprising:
the first fan is configured to push air through the air filters; and
the second fan is configured to pull air from the air filters.

12. The electrically, wearable personal air cleaning device of claim 1 further comprising:
a removable carriage for the air filters.

13. The removable carriage of claim 12 further comprising:
the removable carriage holds a replaceable nanofiber filter and a replaceable large particle prefilter.

14. The electrically, wearable personal air cleaning device of claim 1, further comprising:
a locking mechanism to detach the outlet to the air conduit; and
said locking mechanism to detach the inlet to the air conduit.

15. The electrically, wearable personal air cleaning device of claim 1, further comprising:
a first self-contained electric power source located dorsal of inlet and underneath the air conduit; and
a second self-contained electrical power source, of identical weight to the first self-contained power source, located dorsal of the outlet and underneath the air conduit in about the same distance from the median plane wherein the distance is the shortest possible distance from the volumetric center of the battery to the median plane.
